(19) United States
(12) Patent Application Publication
(10) Pub. No.: US 2015/0144235 A1
(43) Pub. Date: May 28, 2015

(54) COPPER ALLOY TROLLEY WIRE AND METHOD FOR MANUFACTURING COPPER ALLOY TROLLEY WIRE

(71) Applicants: Tetsuya Ashida, Amagasaki-shi (JP); Kouji Hashimoto, Amagasaki-shi (JP); Hitoshi Nakamoto, Osaka (JP); Norikazu Ishida, Tokyo (JP)

(72) Inventors: Tetsuya Ashida, Amagasaki-shi (JP); Kouji Hashimoto, Amagasaki-shi (JP); Hitoshi Nakamoto, Osaka (JP); Norikazu Ishida, Tokyo (JP)

(73) Assignees: MITSUBISHI MATERIALS CORPORATION, Tokyo (JP); MITSUBISHI CABLE INDUSTRIES, LTD., Tokyo (JP)

(21) Appl. No.: 14/415,951

(22) PCT Filed: Jul. 31, 2012
(86) PCT No.: PCT/JP2012/069493

§ 371 Date: Jan. 20, 2015

(51) Int. Cl. C22F 1/08; C22C 9/02; H01B 1/02; C22C 9/06

(52) U.S. Cl. CPC C22F 1/08; C22C 9/06; C22C 9/02; H01B 1/026
USPC 148/685; 148/412

(57) ABSTRACT

A copper alloy trolley wire includes: 0.12 mass % to 0.40 mass % of Co; 0.040 mass % to 0.16 mass % of P; 0.005 mass % to 0.70 mass % of Sn; and the balance including Cu and unavoidable impurities, wherein precipitates have an average grain size of equal to or greater than 10 nm, and the number of precipitates having a grain size of equal to or greater than 5 nm is 90% or greater of the total number of observed precipitates, and a heat resistance HR defined by HR=TS₁/TS₀×100 in which TS₀ is an initial tensile strength and TS₁ is a tensile strength after holding the copper alloy trolley wire at 400° C. for 2 hours, is equal to or greater than 90%.

### CROSS-REFERENCE TO RELATED PATENT APPLICATIONS

This application is a U.S. National Phase Application under 35 U.S.C. §371 of International Patent Application No. PCT/JP2012/069493, filed Jul. 31, 2012, which is incorporated by reference in its entirety herein. The International Application was published in Japanese on Feb. 6, 2014 as International Publication No. WO/2014/020707 under PCT Article 21(2).

### FIELD OF THE INVENTION

The present invention relates to a copper alloy trolley wire which comes in sliding contact with a current collector such as a pantograph provided on a train or the like to supply power to the train or the like, and a method for manufacturing the same.

### BACKGROUND OF THE INVENTION

A trolley wire for railways used in a train or the like is configured to come in sliding contact with a current collector such as a pantograph to be supplied with power as described above and thus needs to secure a predetermined strength, wear resistance, electrical conductivity, heat resistance, and the like.

Hitherto, as the trolley wire, for example, as disclosed in Japanese Examined Patent Application, Second Publication No. S59-043332, a trolley wire made of Sn-containing copper which contains 0.25 weight % to 0.35 weight % of Sn is provided. The Sn-containing copper is a solid solution strengthening type copper alloy which is strengthened by solid-solving Sn in the matrix of copper and has excellent wear resistance and the like.

In recent years, an increase in the running speed of trains has been achieved. However, for high-speed railways such as Shinkansen [bullet trains], when the running speed of the train becomes faster than the propagation speed of waves generated in an overhead wire such as a trolley wire, contact between the current collector such as a pantograph and the trolley wire becomes unstable, and there is concern that stable power supply cannot be performed.

Here, by increasing the overhead wire tension of the trolley wire, the propagation speed of waves in the trolley wire can be increased. Therefore, a trolley wire having a higher strength than that in the related art is required.

Accordingly, for example, in Japanese Unexamined Patent Application, First Publications No. H03-056632, No. H05-311284 and No. H07-266939, a trolley wire made of a copper alloy containing Cr, Zr, and the like is suggested. The copper alloy containing Cr, Zr, and the like is a precipitation strengthening type copper alloy in which the strength thereof is enhanced by precipitating and dispersing a compound that contains Cr or Zr as main components in the matrix, and thus has further improved strength and electrical conductivity.

### Technical Problem

However, regarding the precipitation strengthening type copper alloy containing Cr, Zr, and the like described in Japanese Unexamined Patent Application, First Publications No. H03-056632, No. H05-311284 and No. H07-266939, Cr and Zr are solid-solved in the matrix in a solution heat treatment process, the resultant is shaped into a predetermined shape in a cold working process, and thereafter a compound that contains Cr or Zr as main components is precipitated in an aging heat treatment process. Here, regarding the trolley wire made of the precipitation strengthening type copper alloy, the strength and electrical conductivity thereof are changed by a dispersion state of the precipitates, and thus the dispersion state of the precipitates is controlled by adjusting heat treatment conditions of the aging heat treatment process.

However, regarding the copper alloy containing Cr, Zr, and the like, when the cold working is performed after the aging heat treatment, performance such as electrical conductivity is significantly changed, and thus the aging heat treatment process has to be performed on the copper alloy having a shape that is similar to a final product. Therefore, there is a problem in that the shape after being subjected to the aging heat treatment cannot be sufficiently corrected. For example, in a case of a grooved trolley wire shown in FIG. 1, the aging heat treatment needs to be performed after forming grooves thereon.

In addition, due to an increase in the running speed of trains, a high frictional force is applied to the trolley wire, and thus the temperature of the trolley wire is increased by the frictional heat. Therefore, an improvement in heat resistance further than that according to the related art is required. That is, even in a high temperature state of 200° C., sufficient tensile strength and overhead wire tension needs to be secured.

The present invention has been made taking the foregoing circumstances into consideration, and an object thereof is to provide a copper alloy trolley wire having excellent strength, electrical conductivity, wear resistance, and heat resistance and having excellent shape accuracy, and a method for manufacturing the copper alloy trolley wire.

### SUMMARY OF THE INVENTION

### Solution to Problem

In order to solve the above-described problems, a copper alloy trolley wire according to the present invention includes: 0.12 mass % to 0.40 mass % of Co; 0.040 mass % to 0.16 mass % of P; 0.005 mass % to 0.70 mass % of Sn; and the balance including Cu and unavoidable impurities, wherein precipitates have an average grain size of equal to or greater than 10 nm, and the number of precipitates having a grain size of equal to or greater than 5 nm is 90% or higher of the total number of observed precipitates, and a heat resistance HR defined by HR=TS₁/TS₀×100 in which TS₀ is an initial tensile strength and TS₁ is a tensile strength after holding the copper alloy trolley wire at 400° C. for 2 hours, is equal to or higher than 90%.

Since the copper alloy trolley wire according to the present invention described above has a composition containing: 0.12 mass % to 0.40 mass % of Co; 0.040 mass % to 0.16 mass % of P; 0.005 mass % to 0.70 mass % of Sn; and the balance including Cu and unavoidable impurities, precipitates made of compounds with Co and P are dispersed in the matrix of copper. Accordingly, it is possible to achieve the enhancement of strength and electrical conductivity.

In addition, when the Co content and the P content are lower than the lower limit, the number of precipitates is insufficient, and thus strength cannot be sufficiently enhanced. On the contrary, when the Co content and the P content are higher than the upper limit, a large number of elements that do not contribute to the enhancement of strength are present, and there is concern that a reduction in electrical conductivity and the like may be caused. Therefore, the Co content and the P content are set to the above ranges.

In addition, Sn is an element having an action of solid-solving in the matrix of copper to enhance strength. In addition, Sn also has an effect of accelerating the precipitation of precipitates containing Co and P as main components or can enhance heat resistance and corrosion resistance. In order to reliably achieve the effect, the Sn content needs to be equal to or higher than 0.005 mass %. In addition, in a case where Sn is excessively added, a reduction in electrical conductivity is caused. Therefore, the Sn content needs to be equal to or less than 0.70 mass %.

In addition, it is preferable that the precipitation strengthening type copper alloy further include 0.01 mass % to 0.15 mass % of Ni.

The copper alloy wire having the above composition contains Ni in the above range and thus can suppress the coarsening of grains, thereby further enhancing strength.

In addition, in the copper alloy trolley wire according to the present invention, since the precipitates have an average grain size of equal to or greater than 10 nm and the number of precipitates having a grain size of equal to or greater than 5 nm is 90% or higher of the total number of observed precipitates, it is possible to enhance strength, electrical conductivity, and heat resistance. Here, in a case where the grain size of the precipitate is less than 10 nm, the precipitate containing Co and P as main components is re-solid-solved in the matrix in the subsequent cold working, resulting in a reduction in electrical conductivity.

As described above, in the copper alloy trolley wire of the present invention, the strength thereof is further enhanced by performing the cold working after the aging heat treatment. Accordingly, the shape thereof can be sufficiently corrected by performing the cold working after the aging heat treatment, and thus it is possible to provide the copper alloy trolley wire having excellent shape accuracy.

Furthermore, in the copper alloy trolley wire of the present invention, since the heat resistance HR defined by HR=TS₁/TS₀×100 in which TS₀ is the initial tensile strength and TS₁ is the tensile strength after holding the copper alloy trolley wire at 400° C. for 2 hours, is equal to or higher than 90%, even in a case where the temperature of the copper alloy trolley wire is increased by frictional heat and the like, the tensile strength is sufficiently secured and thus the overhead wire tension of the copper alloy trolley wire can be set to be high. Accordingly, it is possible to apply the copper alloy trolley wire to high-speed railways and the like.

A method for manufacturing a copper alloy trolley wire of the present invention is a method for manufacturing the above-described copper alloy trolley wire and includes: an aging heat treatment process; and a cold working process performed after the aging heat treatment process, wherein a working ratio in the cold working process is set to 20% to 65%.

According to the method for manufacturing the copper alloy trolley wire having the above composition, after the precipitates containing Co and P as main components are precipitated in the aging heat treatment process, working is performed at a working ratio of 20% to 65% in the cold working process. Therefore, a dislocation loop is formed in parts of the precipitates, and thus it is possible to reliably enhance strength. In addition, since the cold working is performed at a working ratio of equal to or higher than 20% after the aging heat treatment process, it is possible to enhance the shape accuracy of the trolley wire.

Here, in a case where the working ratio is less than 20% in the cold working process, there is concern that the enhancement of strength may be insufficient. In addition, in a case where the working ratio is higher than 65% in the cold working process, there is concern that the electrical conductivity may be degraded due to the accumulation of dislocations and re-solid-solving of the precipitates. Therefore, from the viewpoint of securing strength and electrical conductivity, the working ratio in the cold working process is set to be in a range of 20% to 65%.

### Advantageous Effects of Invention

According to the present invention, it is possible to provide a copper alloy trolley wire having excellent strength, electrical conductivity, and heat resistance and having excellent shape accuracy, and a method for manufacturing the copper alloy trolley wire.

### BRIEF DESCRIPTION OF THE DRAWINGS

FIG. 1 is a cross-sectional explanatory view of a copper alloy trolley wire of an embodiment of the present invention.

FIG. 2 is a flowchart of a method for manufacturing the copper alloy trolley wire of the embodiment of the present invention.

FIG. 3 is a schematic explanatory view of a continuous casting and rolling facility used in the method for manufacturing the copper alloy trolley wire of the embodiment of the present invention.

### DETAILED DESCRIPTION OF THE INVENTION

### Description of Embodiments

Hereinafter, a copper alloy trolley wire according to an embodiment of the present invention and a method for manufacturing the copper alloy trolley wire will be described with reference to the accompanying drawings.

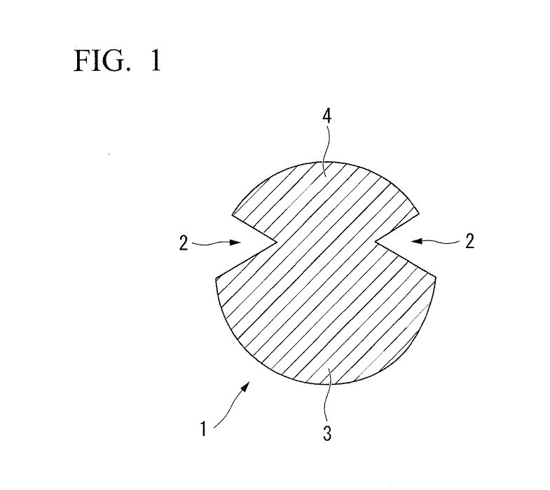

FIG. 1 shows an example of a copper alloy trolley wire 1 of the embodiment of the present invention.

The copper alloy trolley wire 1 of this embodiment is a grooved trolley wire in which grooves 2 to which clasps are attached are formed as shown in FIG. 1. The copper alloy trolley wire 1 includes a first arc portion 3 provided on one side of the grooves 2 (lower side in FIG. 1) and a second arc portion 4 provided on the other side of the grooves 2 (upper side in FIG. 1) and is configured so that the first arc portion 3 comes in sliding contact with a pantograph.

Here, trolley wires for railways are standardized according to cross-sectional areas, and the copper alloy trolley wire 1 of this embodiment has a cross-sectional area of 110 mm².

The copper alloy trolley wire 1 is made of a copper alloy having a composition containing: 0.12 mass % to 0.40 mass % of Co; 0.040 mass % to 0.16 mass % of P; 0.005 mass % to 0.70 mass % of Sn; and the balance including Cu and unavoidable impurities.

In addition, it is preferable that the precipitation strengthening type copper alloy further include 0.01 mass % to 0.15 mass % of Ni.

In addition, the copper alloy may further contain at least any one type of 0.002 mass % to 0.5 mass % of Zn, 0.002 mass % to 0.25 mass % of Mg, 0.002 mass % to 0.25 mass % of Ag, and 0.001 mass % to 0.1 mass % of Zr.

The copper alloy having the above composition contains at least any one type or two or more types of Zn, Mg, Ag, and Zr in the above ranges. Accordingly, such elements form compounds with sulfur (S) to suppress the sulfur (S) from being solid-solved in the matrix of copper, thereby suppressing the deterioration of mechanical properties such as strength.

Hereinafter, the reason that the amount of each of the elements is set to the above range will be described.

### (Co and P)

Co and P are elements that form precipitates which are dispersed in the matrix of copper.

Here, in a case where the Co content is less than 0.12 mass % and the P content is less than 0.040 mass %, the number of precipitates is insufficient and there is concern that the strength may not be sufficiently enhanced. On the contrary, in a case where the Co content is higher than 0.40 mass % and the P content is higher than 0.16 mass %, a large number of elements that do not contribute to the enhancement of strength are present, and there is concern that a reduction in electrical conductivity and the like may be caused.

Therefore, the Co content is set to 0.12 mass % to 0.40 mass % and the P content is set to 0.040 mass % to 0.16 mass %.

### (Sn)

Sn is an element having an action of solid-solving in the matrix of copper to enhance strength. In addition, Sn also has an effect of accelerating the precipitation of precipitates containing Co and P as main components and also has an action of enhancing heat resistance and corrosion resistance.

Here, in a case where a Sn content is less than 0.005 mass %, there is concern that the above-described effect may not be reliably achieved. On the contrary, in a case where the Sn content is higher than 0.70 mass %, there is concern that the electrical conductivity may not be secured.

Therefore, the Sn content is set to a range of 0.005 mass % to 0.07 mass %.

### (Ni)

Ni is an element having an effect of being replaced with a portion of Co and suppressing the coarsening of grains.

Here, in a case where a Ni content is less than 0.01 mass %, there is concern that the above-described effect may not be reliably achieved. On the contrary, in a case where the Ni content is higher than 0.15 mass %, there is concern that the electrical conductivity may not be secured.

Therefore, in a case where Ni is contained, it is preferable that the Ni content be 0.01 mass % to 0.15 mass %.

### (Zn, Mg, Ag, and Zr)

Elements Zn, Mg, Ag, and Zr are elements having an effect of forming compounds with sulfur (S) to suppress the sulfur (S) from being solid-solved in the matrix of copper.

Here, in a case where the contents of the elements Zn, Mg, Ag, and Zr are less than the above-described lower limits, the effect of suppressing the sulfur (S) from being solid-solved in the matrix of copper cannot be sufficiently achieved. On the contrary, in a case where the amounts of the elements Zn, Mg, Ag, and Zr are higher than the above-described upper limits, there is concern that the electrical conductivity may not be secured.

Therefore, in a case where the elements Zn, Mg, Ag, and Zr are contained in the copper alloy, it is preferable that the elements be in the above-described ranges.

In addition, in the copper alloy trolley wire 1 of this embodiment, precipitates have an average grain size of equal to or greater than 10 nm, and the number of precipitates having a grain size of equal to or greater than 5 nm is 90% or higher of the total number of observed precipitates.

Here, the precipitates were observed as follows. The precipitates were observed by a transmission electron microscope at magnifications of 150,000× and 750,000×, the area of the corresponding precipitates was calculated, and a diameter equivalent to a circle thereof is calculated as a grain size. In addition, the precipitates having grain sizes of 11 nm to 100 nm were measured at a magnification of 150,000×, and the precipitates having grain sizes of 1 nm to 10 nm were measured at a magnification of 750,000×. In the observation at the magnification of 750,000×, the precipitates having a grain size of less than 1 nm cannot be clearly determined, and thus the total number of observed precipitates is the number of precipitates having a grain size of equal to or greater than 1 nm. In addition, the observation by the transmission electron microscope was performed on a visual field area of about 4×10⁵ nm² in the case of the magnification of 150,000× and was performed on a visual field area of about 2×10⁴ nm² in the case of the magnification of 750,000×.

In addition, in the copper alloy trolley wire 1 of this embodiment, a heat resistance HR defined by HR=TS₁/TS₀×100 in which TS₀ is the initial tensile strength and TS₁ is the tensile strength after holding the copper alloy trolley wire 1 at 400° C. for 2 hours is equal to or higher than 90%.

In addition, in this embodiment, the measurement of the tensile strength of the copper alloy trolley wire 1 was performed based on JIS Z 2241. In addition, the tensile strength TS₁ after a heat treatment was measured at normal temperature after holding the copper alloy trolley wire 1 at 400° C. for 2 hours.

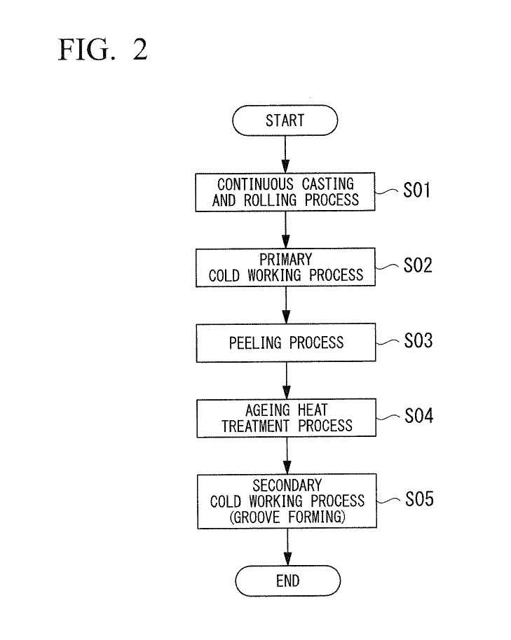

Next, a method for manufacturing the above-described copper alloy trolley wire 1 will be described. FIG. 2 shows a flowchart of the method for manufacturing the copper alloy trolley wire 1 of the embodiment of the invention.

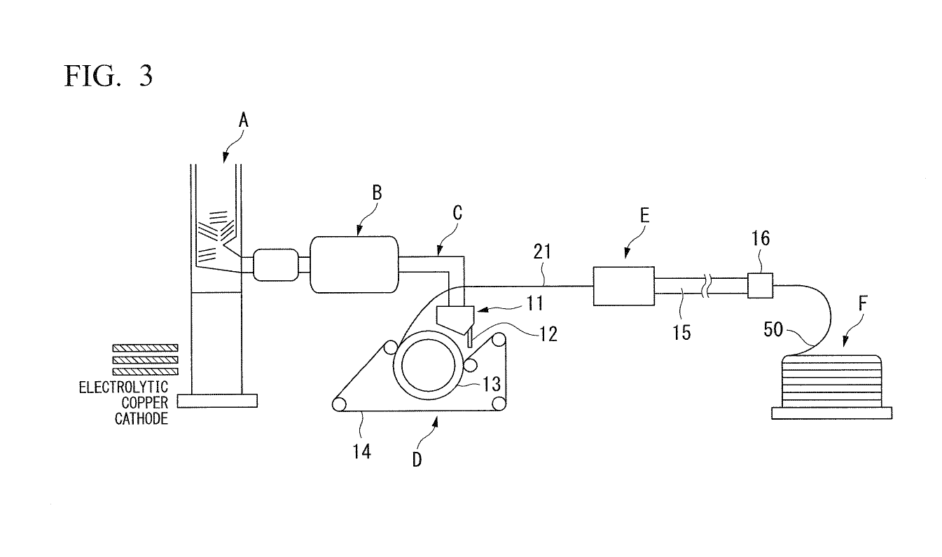

First, a copper wire rod 50 made of the copper alloy is continuously produced according to a continuous casting and rolling method (continuous casting and rolling process S01). In the continuous casting and rolling process S01, for example, a continuous casting and rolling facility shown in FIG. 3 is used.

The continuous casting and rolling facility shown in FIG. 3 includes a melting furnace A, a holding furnace B, a casting launder C, a belt-wheel type continuous casting machine D, a continuous rolling device E, and a coiler F.

In this embodiment, as the melting furnace A, a shaft furnace which includes a cylindrical furnace body is used. A plurality of burners (not shown) are arranged in the circumferential direction in the lower part of the furnace body and are arranged in a multi-stage form in the vertical direction. In addition, electrolytic copper cathode which is a raw material is inserted from the upper part of the furnace body and is melted by the combustion of the burners, thereby continuously producing molten copper.

The holding furnace B temporarily stores the molten copper produced in the melting furnace A while being held at a predetermined temperature and transfers a constant amount of the molten copper to the casting launder C.

The casting launder C transfers the molten copper transferred from the holding furnace B to a tundish 11 disposed above the belt-wheel type continuous casting machine D. The casting launder C is sealed by, for example, an inert gas such as Ar or a reducing gas. In addition, in the casting launder C, degassing means (not shown) for stirring the molten copper using the inert gas to remove oxygen and the like in the molten copper is provided.

The tundish 11 is a storage tank provided to continuously supply the molten copper to the belt-wheel type continuous casting machine D. On the end side of the tundish 11 in the flowing direction of the molten copper, a pouring nozzle 12 is disposed so that the molten copper in the tundish 11 is supplied to the belt-wheel type continuous casting machine D via the pouring nozzle 12.

Here, in this embodiment, alloy element adding means (not shown) is provided in the casting launder C and the tundish 11, the alloy element adding means being configured to add the above-mentioned elements (Co, P, and Sn) to the molten copper.

The belt-wheel type continuous casting machine D includes a casting wheel 13 having a groove formed in the outer circumferential surface, and an endless belt 14, which revolves around the outer circumferential surface of the casting wheel 13 so as to come into contact with a part of the outer circumferential surface of the casting wheel 13. In the belt-wheel type continuous casting machine D, the molten copper is poured into a space formed between the groove and the endless belt 14 via the pouring nozzle 12, and the molten copper is cooled and solidified, thereby continuously casting a rod-like cast copper 21.

The continuous rolling device E is connected to the downstream side of the belt-wheel type continuous casting machine D. The continuous rolling device E continuously rolls the cast copper 21 produced from the belt-wheel type continuous casting machine D, thereby producing a copper wire rod 50 having a predetermined outside diameter.

The copper wire rod 50 produced from the continuous rolling device E passes through a washing and cooling device 15 and a flaw detector 16 and is wound around the coiler F.

Here, the outside diameter of the copper wire rod 50 produced by the continuous casting and rolling facility described above is, for example, 8 mm to 30 mm, and in this embodiment, is 27 mm.

In addition, in the continuous casting and rolling process S01, the cast copper 21 is held at a relatively high temperature of, for example, 800° C. to 1000° C., and therefore, a large amount of the elements, such as Co and P, are solid-solved in the matrix of copper.

Next, as shown in FIG. 2, the copper wire rod 50 produced in the continuous casting and rolling process S01 is subjected to the cold working (primary cold working process S02). In the primary cold working process S02, the copper wire rod 50 is processed into a copper wire material having a predetermined cross-sectional shape by a die wire drawing method, a rolling method, swaging, or the like. At this time, for the purpose of reducing working resistance, reducing wear of a die or a roll, cooling materials, and the like, an oil-based lubricant is used.

Next, the copper wire material is peeled (peeling process S03). In the peeling process 03, a surface layer of 0.1 to 0.5 mm, preferably, a surface layer of 0.1 to 0.2 mm is removed by using a peeling die. The copper wire material obtained in the peeling process S03 has a diameter of about 13 to 22 mm, and in this embodiment, is 18 mm.

Next, the copper wire material after the peeling process S03 is subjected to an aging heat treatment (aging heat treatment process S04). In the aging heat treatment process S04, precipitates made of a compound that contains Co and P as a main component are precipitated.

Here, in the aging heat treatment process S04, the aging heat treatment is performed under the conditions of a temperature increase rate of 50° C./h to 300° C./h, a heat treatment temperature of 300° C. to 600° C., and a holding time of 0.5 hours to 6 hours.

Next, the copper wire material after the aging heat treatment process S04 is subjected to cold working to produce a copper alloy trolley wire having a predetermined cross-sectional shape (secondary cold working process S05).

Here, a working ratio in the secondary cold working process S05 is set to be 20% to 65%.

In the secondary cold working process S05, the copper wire material having a circular cross-section is subjected to groove forming to produce the copper alloy trolley wire 1 having the cross-sectional shape shown in FIG. 1.

According to the copper alloy trolley wire 1 of the embodiment configured as described above and the method for manufacturing the copper alloy trolley wire 1, the composition thereof contains: 0.12 mass % to 0.40 mass % of Co; 0.040 mass % to 0.16 mass % of P; 0.005 mass % to 0.70 mass % of Sn; and the balance including Cu and unavoidable impurities. Accordingly, precipitates made of compounds of Co and P are dispersed in the matrix of copper, and thus it is possible to achieve the enhancement of strength and electrical conductivity.

Here, in this embodiment, since the Co content is set to a range of 0.12 mass % to 0.40 mass % and the P content is set to a range of 0.040 mass % to 0.16 mass %, the number of precipitates is secured and thus strength can be sufficiently enhanced. In addition, the number of extra Co and P that does not contribute to the enhancement of strength is not large and thus electrical conductivity can be secured.

In addition, the Sn content is equal to or higher than 0.005 mass %. Therefore, Sn is solid-solved in the matrix of copper and thereby strength can be enhanced, and the precipitation of a precipitate containing Co and P as main components can be accelerated and thereby enhancing heat resistance and corrosion resistance. On the other hand, since the Sn content is equal to or less than 0.70 mass %, the degradation of electrical conductivity can be suppressed.

In addition, in this embodiment, as necessary, the composition contains any one or more types of 0.002 mass % to 0.5 mass % of Zn, 0.002 mass % to 0.25 mass % of Mg, 0.002 mass % to 0.25 mass % of Ag, and 0.001 mass % to 0.1 mass % of Zr. When such elements are added, S is prevented from being solid-solved in the matrix of copper, and thus the degradation of performance due to the S can be prevented. Furthermore, with such elements, a further enhancement of strength can be achieved.

In the copper alloy trolley wire 1 of this embodiment, the precipitates have an average grain size of equal to or greater than 10 nm, and the number of precipitates having a grain size of equal to or greater than 5 nm is 90% or higher of the total number of observed precipitates. Therefore, it is possible to enhance strength, electrical conductivity, and heat resistance.

In addition, in the copper alloy trolley wire 1 of this embodiment, the strength thereof is further enhanced by being subjected to the cold working after the aging heat treatment. Accordingly, the shape thereof can be sufficiently corrected by performing the cold working after the aging heat treatment, and thus it is possible to provide the copper alloy trolley wire 1 having excellent shape accuracy.

Furthermore, in the copper alloy trolley wire 1 of this embodiment, since a heat resistance HR defined by HR=TS₁/TS₀×100 in which TS₀ is the initial tensile strength and TS₁ is the tensile strength after holding the copper alloy trolley wire 1 at 400° C. for 2 hours, is equal to or higher than 90%, even in a case where the temperature of the copper alloy trolley wire 1 is increased by frictional heat and the like, the tensile strength is sufficiently secured and thus the overhead wire tension of the copper alloy trolley wire 1 can be set to be high. Accordingly, it is possible to apply the copper alloy trolley wire 1 to high-speed railways and the like.

In addition, in the method for manufacturing the copper alloy trolley wire 1 of this embodiment, the aging heat treatment process S04 and the secondary cold working process S05 performed after the aging heat treatment process S04 are provided, and working is performed at a working ratio of 20% to 65% in the secondary cold working process S05. Therefore, strength can be reliably enhanced and it is possible to secure electrical conductivity. That is, in a case where the working ratio is less than 20% in the secondary cold working process S05, there is concern that the enhancement of strength may be insufficient. In addition, in a case where the working ratio is higher than 65% in the secondary cold working process S05, there is concern that the electrical conductivity may be degraded due to the accumulation of dislocations and re-solid-solving of the precipitates.

Furthermore, in this embodiment, since the aging treatment process S04 of performing a heat treatment at 300° C. to 600° C. for 0.5 hours to 6 hours to precipitate precipitates is provided before the secondary cold working process S05, the size and the density of the precipitates dispersed in the matrix of copper can be adjusted. For example, the average grain size thereof can be set to equal to or greater than 10 nm and the number of precipitates having a grain size of equal to or greater than 5 nm can be set to 90% or higher of the total number of observed precipitates. Accordingly, the enhancement of strength can be achieved.

In addition, in the method for manufacturing the copper alloy trolley wire 1 of this embodiment, since the copper wire rod 50 is produced in the continuous casting and rolling process S01, the copper wire rod 50 can be efficiently produced. In addition, since the copper wire rod 50 is held for a predetermined time in a high temperature state of, for example, 800 to 1000° C., the elements Co, P, and the like are solid-solved in the matrix of copper. Accordingly, an additional solution heat treatment is not necessary.

While the embodiment of the present invention has been described, the present invention is not limited thereto, and modifications can be appropriately made without departing from the technical spirit of the present invention.

For example, the copper alloy trolley wire having the cross-sectional shape shown in FIG. 1 is described in this embodiment. However, the present invention is not limited thereto, and a copper alloy trolley wire having another cross-sectional shape may also be applied. In addition, the trolley wire for railways has been described. However, the present invention is not limited thereto, and the copper alloy trolley wire may also be used for transport equipment such as a crane.

In addition, in this embodiment, the copper wire rod is manufactured by the continuous casting and rolling process in the description. However, the present invention is not limited thereto, and a columnar ingot (billet) may be produced and the ingot may be extruded and cold-worked to produce the copper wire rod. In a case where the copper wire rod is produced by the extrusion method, an additional solution heat treatment needs to be performed. Furthermore, even in a case where the copper wire rod is manufactured by the continuous casting and rolling process, a solution heat treatment may also be performed thereon.

In addition, in this embodiment, the continuous casting and rolling process is performed by using the belt-wheel type continuous casting machine shown in FIG. 3 in the description. However, the present invention is not limited thereto, and another continuous casting method may also be employed.

### EXAMPLES

Hereinafter, the results of a confirmation test performed to check the effectiveness of the present invention will be described.

By using a continuous casting and rolling facility provided with a belt-wheel type continuous casting machine, a copper wire rod (a diameter of 27 mm) made of a copper alloy having a composition shown in Table 1 was produced. The copper wire rod was subjected to primary cold working to have a diameter of 20 nm, to peeling. and then to an aging heat treatment under the conditions shown in Table 1. Thereafter, secondary cold working was performed under the conditions shown in Table 1, thereby manufacturing a grooved trolley wire having a cross-sectional area of 110 mm².

In addition, precipitates were observed by using the manufactured grooved trolley wire. The observation of the precipitates was performed by using a transmission electron image of a transmission electron microscope (TEM, model name: H-800, HF-2000, and HF-2200 made by Hitachi, Ltd., and JEM-2010F made by JEOL Ltd.), and an equivalent grain size was calculated from the area of each precipitate. In addition, the observation was performed at magnifications of 150,000× and 750,000× on visual field areas of about 4×10⁵ nm² and 2×10⁴ nm², respectively. In addition, the average grain size of the precipitates and the ratio of the number of the precipitates having a grain size of equal to or greater than 5 mm to the total number of the observed precipitates were calculated. The results are shown in Table 2.

In addition, by using the manufactured grooved trolley wires, heat resistance HR, tensile strength, elongation, and electrical conductivity were evaluated.

The heat resistance HR is defined by HR=TS₁/TS₀×100 in which TS₀ is the initial tensile strength and TS₁ is the tensile strength after holding the trolley wire at 400° C. for 2 hours, and was calculated by measuring the initial tensile strength TS₀ and the tensile strength TS₁ after holding the trolley wire at 400° C. for 2 hours by using AG-100kNX made by Shimadzu Corporation on the basis of JIS Z 2241.

The tensile strength and the elongation were measured by using the AG-100kNX made by Shimadzu Corporation on the basis of JIS Z 2241 as described above.

The electrical conductivity was measured on the basis of JIS H 0505 according to a double bridge method.

In addition, for tough pitch copper as Related Art Example 1 and Cu-0.3 wt % Sn as Related Art Example 2, heat resistance, tensile strength, elongation, and electrical conductivity were measured.

The evaluation results are shown in Table 2.

TABLE 1

| | | | | | | | Secondary cold |
|---|---|---|---|---|---|---|---|
| | Composition (wt %) | | | | Aging heat treatment process | | working process |
| | Co | P | Sn | Others | Temperature (° C.) | Time (h) | Working ratio (%) |
| Invention Example 1 | 0.25 | 0.08 | 0.10 | — | 520 | 1 | 50 |
| Invention Example 2 | 0.40 | 0.16 | 0.16 | — | 520 | 1 | 50 |
| Invention Example 3 | 0.12 | 0.04 | 0.08 | — | 520 | 1 | 50 |
| Invention Example 4 | 0.30 | 0.11 | 0.70 | — | 520 | 1 | 50 |
| Invention Example 5 | 0.22 | 0.07 | 0.005 | — | 520 | 1 | 50 |
| Invention Example 6 | 0.25 | 0.09 | 0.09 | — | 520 | 1 | 65 |
| Invention Example 7 | 0.27 | 0.08 | 0.11 | — | 520 | 1 | 20 |
| Invention Example 8 | 0.26 | 0.09 | 0.08 | — | 500 | 1 | 50 |
| Invention Example 9 | 0.24 | 0.08 | 0.09 | — | 540 | 4 | 50 |
| Comparative Example 1 | 0.42 | 0.20 | 0.08 | — | 520 | 1 | 50 |
| Comparative Example 2 | 0.10 | 0.02 | 0.12 | — | 520 | 1 | 50 |
| Comparative Example 3 | 0.26 | 0.08 | 0.75 | — | 520 | 1 | 50 |
| Comparative Example 4 | 0.27 | 0.09 | 0.003 | — | 520 | 1 | 50 |
| Comparative Example 5 | 0.25 | 0.08 | 0.08 | — | 480 | 1 | 50 |

| | |
|---|---|
| Related Art Example 1 | Tough pitch copper |
| Related Art Example 2 | Cu—0.3Sn |

TABLE 2

| | Observation results of precipitates | | Heat | Tensile | | Electrical |
|---|---|---|---|---|---|---|
| | Average grain size | Ratio of 5 nm or greater | resistance | strength | Elongation | conductivity |
| | (nm) | (%) | (%) | (MPa) | (%) | (% IACS) |
| Invention Example 1 | 13 | 93 | 92 | 520 | 5 | 80 |
| Invention Example 2 | 14 | 92 | 93 | 580 | 4 | 76 |
| Invention Example 3 | 11 | 91 | 91 | 460 | 5 | 82 |
| Invention Example 4 | 11 | 91 | 93 | 590 | 4 | 76 |
| Invention Example 5 | 14 | 90 | 91 | 450 | 5 | 84 |
| Invention Example 6 | 12 | 90 | 92 | 540 | 4 | 76 |
| Invention Example 7 | 13 | 94 | 91 | 470 | 5 | 82 |
| Invention Example 8 | 11 | 91 | 91 | 500 | 5 | 78 |
| Invention Example 9 | 17 | 95 | 91 | 480 | 5 | 82 |
| Comparative Example 1 | 15 | 89 | 91 | 600 | 3 | 74 |
| Comparative Example 2 | 9 | 89 | 89 | 420 | 5 | 82 |
| Comparative Example 3 | 11 | 89 | 90 | 600 | 3 | 73 |
| Comparative Example 4 | 8 | 92 | 89 | 400 | 4 | 83 |
| Comparative Example 5 | 9 | 87 | 88 | 520 | 5 | 73 |
| Related Art Example 1 | — | — | 70 | 350 | 5 | 97 |
| Related Art Example 2 | — | — | 60 | 440 | 4 | 78 |

In Comparative Example 1 in which the Co content and P content were higher than the upper limit of the present invention, it was confirmed that the electrical conductivity was low.

In Comparative Example 2 in which the Co content and P content were lower than the lower limit of the present invention, the tensile strength was insufficient.

In Comparative Example 3 in which the Sn content was higher than the upper limit of the present invention, it was confirmed that the electrical conductivity was low.

In Comparative Example 4 in which the Sn content was lower than the lower limit of the present invention, the tensile strength was insufficient.

In Comparative Example 5 in which the average grain size of the precipitates and the ratio of the number of the precipitates having a grain size of equal to or greater than 5 mm to the total number of the observed precipitates were not in the range of the present invention, the electrical conductivity was low.

In addition, in Related Art Examples 1 and 2, the tensile strength was insufficient and the heat resistance was also insufficient.

Contrary to this, in Invention Examples 1 to 9, it was confirmed that strength, electrical conductivity, and heat resistance were excellent.

From the above results of the confirmation test, according to the present invention, it was confirmed that it is possible to stably provide a copper alloy trolley wire having excellent strength, electrical conductivity, and heat resistance.

### INDUSTRIAL APPLICABILITY

The present invention relates to a copper alloy trolley wire having excellent strength, electrical conductivity, wear resistance, and heat resistance and having excellent shape accuracy, and a method for manufacturing the copper alloy trolley wire.

### REFERENCE SIGNS LIST

1 COPPER ALLOY TROLLEY WIRE
2 GROOVE
3 FIRST ARC PORTION
4 SECOND ARC PORTION

1. A copper alloy trolley wire comprising:
0.12 mass % to 0.40 mass % of Co;
0.040 mass % to 0.16 mass % of P;
0.005 mass % to 0.70 mass % of Sn; and
the balance including Cu and unavoidable impurities,
wherein precipitates have an average grain size of equal to or greater than 10 nm, and the number of precipitates having a grain size of equal to or greater than 5 nm is 90% or greater of the total number of observed precipitates, and
a heat resistance HR defined by HR=TS₁/TS₀×100 in which TS₀ is an initial tensile strength and TS₁ is a tensile strength after holding the copper alloy trolley wire at 400° C. for 2 hours, is equal to or greater than 90%.

2. A method for manufacturing the copper alloy trolley wire according to claim 1, comprising:
an aging heat treatment process; and
a cold working process performed after the aging heat treatment process,
wherein a working ratio in the cold working process is set to 20% to 65%.
